(19) United States
(12) Patent Application Publication
(10) Pub. No.: US 2017/0171729 A1
(43) Pub. Date: Jun. 15, 2017

(54) SYSTEMS AND METHODS OF ANNOUNCING DEVICE COMMUNICATION AVAILABILITY

(71) Applicant: EUKUMA TECHNOLOGIES INC., Toronto (CA)

(72) Inventors: Darius Fox, Toronto (CA); Robert Donnelly, Toronto (CA)

(21) Appl. No.: 15/373,995

(22) Filed: Dec. 9, 2016

Related U.S. Application Data
(60) Provisional application No. 62/266,308, filed on Dec. 11, 2015.

(51) Int. Cl. H04W 4/20; H04L 29/12; H04W 48/10

(52) U.S. Cl. CPC H04W 4/206; H04W 48/10; H04L 61/1588; H04W 84/12

(57) ABSTRACT

Systems and methods of announcing device communication availability are disclosed. A first computing device encodes first profile information into an announcement message. The announcement message includes an address field for storing a data link layer address, and the first profile information is encoded into the data link layer address stored in the address field. The first computing device then broadcasts the announcement message. Upon receipt of the announcement message at a second computing device, the second computing device decodes the data link layer address stored in the address field of the announcement message, to extract the first profile information. The second computing device compares the first profile information to second profile information stored at the second computing device; and based on the comparison, determines whether the first computing device is suitable for communication with the second computing device.

### CROSS REFERENCE TO RELATED APPLICATIONS

This application claims priority to U.S. provisional patent application No. 62/266,308, filed on Dec. 11, 2015, the entire contents of which is incorporated by reference herein.

### FIELD OF THE DISCLOSURE

The present disclosure relates generally to systems and methods for establishing communications between computing devices, and specifically, to systems and methods for announcing device communication availability.

### BACKGROUND

Computing devices within close proximity to each other (e.g., in a coffee shop or other social venue) often have capabilities that enable them to create a direct network connection with each other (e.g., protocol stacks for enabling ad-hoc or mesh networks). However, such direct connections are usually only created between computing devices where their users already have pre-existing relationships with each other.

Despite the availability of technology to allow for direct network connection between proximate computing devices, there is no easy way for users of a given computing device to determine whether nearby other computing devices are suitable for communication. There is thus a need for improved systems and methods announcing device communication availability.

### BRIEF DESCRIPTION OF THE DRAWINGS

Non-limiting examples of various embodiments of the present disclosure will next be described in relation to the drawings, in which:

FIG. 1 is a block diagram of a system for announcing device communication availability, in accordance with at least one embodiment of the present invention;

FIG. 2 is a flowchart diagram illustrating steps performed by a first computing device and a second computing device in a system for announcing device communication availability, in accordance with at least one embodiment of the present invention;

FIG. 3 is a diagram illustrating the format of a 802.11 beacon frame having a data link layer address in which profile information may be encoded, in accordance with at least one embodiment of the present invention;

FIG. 4 is a format of a 64-bit MAC address in which profile information may be encoded, in accordance with at least one embodiment of the present invention;

FIG. 5 is a format of a data link layer address for use with the Bluetooth™ protocol, in which profile information may be encoded, in accordance with at least one embodiment of the present invention;

FIG. 6 is a comparison between first profile information extracted from a data link layer address and second profile information, where the first and second profile information are respective answers to binary questions, in accordance with at least one embodiment of the present invention;

FIGS. 7-8 are example user interfaces that may be shown at a second computing device if it is determined that a first computing device is suitable for communication with the second computing device, in accordance with at least one embodiment of the present invention;

FIG. 9 is a flowchart diagram illustrating steps performed by a computing device configured to encode profile information and scan for neighboring computing devices that are suitable for communication, in accordance with at least one embodiment of the present invention;

FIG. 10 is an example survey for which answers may be encoded into a data link layer address, in accordance with at least one embodiment of the present invention;

FIG. 11 is an example layout of a non-OUI portion of a MAC address, with the profile information generated from answers to the example survey of FIG. 10 encoded therein, in accordance with at least one embodiment of the present invention;

FIG. 12 are example profile categories that may be associated with profile information generated from answers to the example survey of FIG. 10, in accordance with at least one embodiment of the present invention; and

FIG. 13 are example comparisons between the encoded profile information of FIG. 11 and the profile categories of FIG. 12, for assigning the answers to a profile category, in accordance with at least one embodiment of the present invention.

### DETAILED DESCRIPTION

In a first broad aspect of the present disclosure, there is provided a method of announcing communication availability from a first computing device. The method includes: encoding first profile information into an announcement message, wherein the announcement message includes an address field for storing a data link layer address, and the first profile information is encoded into the data link layer address stored in the address field; and broadcasting the announcement message; wherein upon receipt of the announcement message at a second computing device, the second computing device: decodes the data link layer address stored in the address field of the announcement message, to extract the first profile information, compares the first profile information to second profile information stored at the second computing device, and based on the comparison, determines whether the first computing device is suitable for communication with the second computing device.

In some embodiments, the announcement message is formatted according to Institute of Electrical and Electronics Engineers (IEEE) 802 standards. In some embodiments, the data link layer address includes a BD_ADDR address for use with a Bluetooth™ protocol. In some embodiments, the data link layer address includes a Medium Access Control (MAC) address. In some embodiments, the announcement message includes a beacon frame of the IEEE 802.11 standard.

In some embodiments, the data link layer address includes an Organizationally Unique Identifier (OUI) portion and a non-OUI portion, and the first profile information is encoded into the non-OUI portion of the data link layer address. In some embodiments, prior to decoding the data link layer address stored in the address field of the announcement message, the second computing device: reads the OUI portion of the data link layer address, compares the OUI portion of the data link layer address to OUI information stored at the second computing device, the OUI information stored at the second computing device being associated with computing devices that perform the encoding, and determines to proceed with the decoding if the OUI portion of the data link layer address matches any of the OUI information stored at the second computing device.

In some embodiments, the first profile information corresponds to a first profile category of a plurality of available profile categories, and the second profile information corresponds to a second profile category of the plurality of available profile categories. In some embodiments, the second computing device determines that the first computing device is not suitable for communication with the second computing device if the comparison indicates the first profile category is sufficiently dissimilar to the second profile category.

In some embodiments, the second computing device determines that the first computing device is suitable for communication with the second computing device if the comparison indicates the first profile category is sufficiently similar to the second profile category.

In some embodiments, the first profile category is determined to be sufficiently similar to the second profile category when the first profile category matches the second profile category.

In some embodiments, each of the plurality of available profile categories are associated with possible answers to questions in a survey, and the first profile information includes answers to the questions in the survey, and wherein the first profile category is determined based on similarities between the answers in the first profile information and the possible answers associated with the first profile category. In some embodiments, the similarities between the answers in the first profile information and the possible answers associated with the first profile category are determined based on a k-nearest neighbor analysis of the answers in the first profile information against the possible answers associated with each of the plurality of available profile categories.

In some embodiments, the first profile category is determined to be sufficiently similar to the second profile category if there are common potential answers between the possible answers associated with the first profile category and the possible answers associated with the second profile category.

In some embodiments, the first profile information includes first answers to binary questions in a survey, and each of the first answers to the binary questions are encoded into a corresponding bit of the data link layer address. In some embodiments, the second profile information includes second answers to the binary questions in the survey, and each of the second answers to the binary questions are encoded into a corresponding bit of a binary string.

In some embodiments, the comparison of the first profile information to the second profile information includes calculating a hamming distance between (i) the bits of the data link layer address having the encoded first answers to the binary questions and (ii) the binary string having the encoded second answers to the binary questions, and wherein the first computing device is determined to be suitable for communication with the second computing device if the hamming distance is less than a threshold number.

In some embodiments, the second computing device determines that the first computing device is not suitable for communication with the second computing device if the first profile information is sufficiently dissimilar to the second profile information.

In some embodiments, during the encoding of the data link layer address into the address field of the announcement message, the data link layer address temporarily overwrites a burned-in data link layer address of the first computing device.

In some embodiments, upon determining that the first computing device is suitable for communication, the second computing device: outputs a notification, and transmits a signal to the first computing device to request initiation of a network communication. In some embodiments, the network communication requested to be initiated by the second computing device includes a network configured according to an Ad-Hoc mode of the IEEE 802.11 standard. In some embodiments, the network communication requested to be initiated by the second computing device includes a mesh network.

In some embodiments, upon determining that the first computing device is suitable for communication, the second computing device records interaction information about the announcement message received from the first computing device, wherein the interaction information is subsequently read by the second computing device to output a reminder notification that the first computing device had been determined to be suitable for communication with the second computing device. In some embodiments, the interaction information includes one or more of the following: location information of where the second computing device received the announcement message, a timestamp indicating when the second computing device received the announcement message, the data link layer address stored in the address field of the announcement message, and the second profile information stored at the second computing device.

In another broad aspect of the present disclosure, there is provided a first computing device including a processor and a memory for storing instructions which, when executed by the processor, cause the processor to: encode first profile information into an announcement message, wherein the announcement message includes an address field for storing a data link layer address, and the first profile information is encoded into the data link layer address stored in the address field; and broadcast the announcement message; wherein upon receipt of the announcement message at a second computing device, the second computing device: decodes the data link layer address stored in the address field of the announcement message, to extract the first profile information, compares the first profile information to second profile information stored at the second computing device, and based on the comparison, determines whether the first computing device is suitable for communication with the second computing device.

In another broad aspect of the present disclosure, there is provided a computer readable medium storing instructions for announcing communication availability, wherein when the instructions are executed by a processor of a first computing device, the instructions cause the processor to: encode first profile information into an announcement message, wherein the announcement message includes an address field for storing a data link layer address, and the first profile information is encoded into the data link layer address stored in the address field; and broadcast the announcement message; wherein upon receipt of the announcement message at a second computing device, the second computing device: decodes the data link layer address stored in the address field of the announcement message, to extract the first profile information, compares the first profile information to second profile information stored at the second computing device, and based on the comparison, determines whether the first computing device is suitable for communication with the second computing device.

In another broad aspect of the present disclosure, there is provided a method of determining whether a first computing device is suitable for communication with a second computing device, the method including the second computing device: receiving an announcement message from the first computing device, the announcement message including an address field for storing a data link layer address; decoding the data link layer address stored in the address field of the announcement message, to extract first profile information; comparing the first profile information to second profile information stored at the second computing device; and based on the comparison, determining whether the first computing device is suitable for communication with the second computing device.

In some embodiments, the announcement message is formatted according to Institute of Electrical and Electronics Engineers (IEEE) 802 standards. In some embodiments, the data link layer address includes a BD_ADDR address for use with a Bluetooth™ protocol. In some embodiments, the data link layer address includes a Medium Access Control (MAC) address. In some embodiments, the announcement message includes a beacon frame of the IEEE 802.11 standard.

In some embodiments, the data link layer address includes an Organizationally Unique Identifier (OUI) portion and a non-OUI portion, and the first profile information is encoded into the non-OUI portion of the data link layer address. In some embodiments, prior to decoding the data link layer address stored in the address field of the announcement message, the method further includes the second computing device: reading the OUI portion of the data link layer address, comparing the OUI portion of the data link layer address to OUI information stored at the second computing device, the OUI information stored at the second computing device being associated with computing devices that perform the encoding, and determining to proceed with the decoding if the OUI portion of the data link layer address matches any of the OUI information stored at the second computing device.

In some embodiments, the first profile information corresponds to a first profile category of a plurality of available profile categories, and the second profile information corresponds to a second profile category of the plurality of available profile categories. In some embodiments, the method further includes the second computing device: determining that the first computing device is not suitable for communication with the second computing device if the comparison indicates the first profile category is sufficiently dissimilar to the second profile category.

In some embodiments, the method further includes the second computing device: determining that the first computing device is suitable for communication with the second computing device if the comparison indicates the first profile category is sufficiently similar to the second profile category.

In some embodiments, the first profile category is determined to be sufficiently similar to the second profile category when the first profile category matches the second profile category.

In some embodiments, each of the plurality of available profile categories are associated with possible answers to questions in a survey, and the first profile information includes answers to the questions in the survey, and wherein the first profile category is determined based on similarities between the answers in the first profile information and the possible answers associated with the first profile category. In some embodiments, the similarities between the answers in the first profile information and the possible answers associated with the first profile category are determined based on a k-nearest neighbor analysis of the answers in the first profile information against the possible answers associated with each of the plurality of available profile categories.

In some embodiments, the first profile category is determined to be sufficiently similar to the second profile category if there are common potential answers between the possible answers associated with the first profile category and the possible answers associated with the second profile category.

In some embodiments, the first profile information includes first answers to binary questions in a survey, and each of the first answers to the binary questions are encoded into a corresponding bit of the data link layer address. In some embodiments, the second profile information includes second answers to the binary questions in the survey, and each of the second answers to the binary questions are encoded into a corresponding bit of a binary string.

In some embodiments, the comparison of the first profile information to the second profile information includes calculating a hamming distance between (i) the bits of the data link layer address having the encoded first answers to the binary questions and (ii) the binary string having the encoded second answers to the binary questions, and wherein the first computing device is determined to be suitable for communication with the second computing device if the hamming distance is less than a threshold number.

In some embodiments, the method further includes the second computing device: determining that the first computing device is not suitable for communication with the second computing device if the first profile information is sufficiently dissimilar to the second profile information.

In some embodiments, upon determining that the first computing device is suitable for communication, the method further includes the second computing device: outputting a notification, and transmitting a signal to the first computing device to request initiation of a network communication. In some embodiments, the network communication requested to be initiated by the second computing device includes a network configured according to an Ad-Hoc mode of the IEEE 802.11 standard. In some embodiments, the network communication requested to be initiated by the second computing device includes a mesh network.

In some embodiments, upon determining that the first computing device is suitable for communication, the method further includes the second computing device: recording interaction information about the announcement message received from the first computing device, wherein the interaction information is subsequently read by the second computing device to output a reminder notification that the first computing device had been determined to be suitable for communication with the second computing device. In some embodiments, the interaction information includes one or more of the following: location information of where the second computing device received the announcement message, a timestamp indicating when the second computing device received the announcement message, the data link layer address stored in the address field of the announcement message, and the second profile information stored at the second computing device.

In another broad aspect of the present disclosure, there is provided a second computing device including a processor and a memory for storing instructions for determining whether a first computing device is suitable for communication with the second computing device, wherein when the instructions are executed by the processor, the processor: receives an announcement message from the first computing device, the announcement message including an address field for storing a data link layer address; decodes the data link layer address stored in the address field of the announcement message, to extract first profile information; compares the first profile information to second profile information stored at the second computing device; and based on the comparison, determines whether the first computing device is suitable for communication with the second computing device.

In another broad aspect of the present disclosure, there is provided a computer readable medium storing instructions for determining whether a first computing device is suitable for communication with a second computing device, wherein when the instructions are executed by a processor of the second computing device, the instructions cause the processor to: receive an announcement message from a first computing device, the announcement message including an address field for storing a data link layer address; decode the data link layer address stored in the address field of the announcement message, to extract first profile information; compare the first profile information to second profile information stored at the second computing device; and based on the comparison, determine whether the first computing device is suitable for communication with the second computing device.

In another broad aspect of the present disclosure, there is provided a system for announcing communication availability, the system including a first computing device and a second computing device. The first computing device is configured to: encode first profile information into an announcement message, wherein the announcement message includes an address field for storing a data link layer address, and the first profile information is encoded into the data link layer address stored in the address field, and broadcast the announcement message. The second computing device configured to: receive the announcement message from the first computing device, decode the data link layer address stored in the address field of the announcement message, to extract the first profile information; compare the first profile information to second profile information stored at the second computing device; and based on the comparison, determine whether the first computing device is suitable for communication with the second computing device.

For simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, certain steps, signals, protocols, software, hardware, networking infrastructure, circuits, structures, techniques, well-known methods, procedures and components have not been described or shown in detail in order not to obscure the embodiments generally described herein.

Furthermore, this description is not to be considered as limiting the scope of the embodiments described herein in any way. It should be understood that the detailed description, while indicating specific embodiments, are given by way of illustration only, since various changes and modifications within the scope of the disclosure will become apparent to those skilled in the art from this detailed description.

The embodiments of the methods described herein may be implemented in hardware or software, or a combination of both. In some cases, embodiments may be implemented in one or more computer programs executing on one or more programmable computing devices (e.g., the various devices discussed below) including at least one processor (e.g., a microprocessor), a data storage device (including in some cases volatile and non-volatile memory and/or data storage elements), at least one communications interface (e.g., a network interface card for wired or wireless network communications, as discussed below), at least one input device, and at least one output device. For example and without limitation, the programmable computing devices may be a personal computer, laptop, personal data assistant, cellular telephone, smartphone device, tablet computer, smartwatch, and/or wireless device. Additional examples of programmable computing devices are also discussed below. Program code is applied to input data to perform the functions described herein and generate output information. The output information is applied to one or more output devices.

Those of skill in the art will understand that the following description of illustrative embodiments of the disclosure does not limit the implementation of embodiments of the disclosure to any particular computer programming language. For example, in some embodiments, each program, module, or application may be implemented in a high level procedural or object oriented programming and/or scripting language to communicate with a computer system. However, the programs can be implemented in assembly or machine language, if desired. In any case, the language may be a compiled or interpreted language.

More specifically, embodiments of the disclosure may be implemented in any computer programming language provided that the operating system (O/S) provides the facilities that may support the present disclosure. For instance, an embodiment of the present disclosure may be implemented in part in the JAVA™ computer programming language (or other computer programming languages such as C, C++, Objective-C, C#, or Swift). Those skilled in the art will also appreciate that any limitations presented by such an embodiment would be a result of a particular type of operating system or computer programming/scripting language and would not be a limitation of the present disclosure.

In some embodiments, the computing devices and methods as described herein may also be implemented as a transitory or non-transitory computer-readable storage medium configured with a computer program, wherein the storage medium so configured causes a computing device to operate in a specific and predefined manner to perform at least some of the functions as described herein. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled, non-compiled, bytecode, or other forms in which the instructions may be interpreted or translated.

Additional aspects and advantages of the present disclosure will be apparent in view of the description which follows.

### OVERVIEW

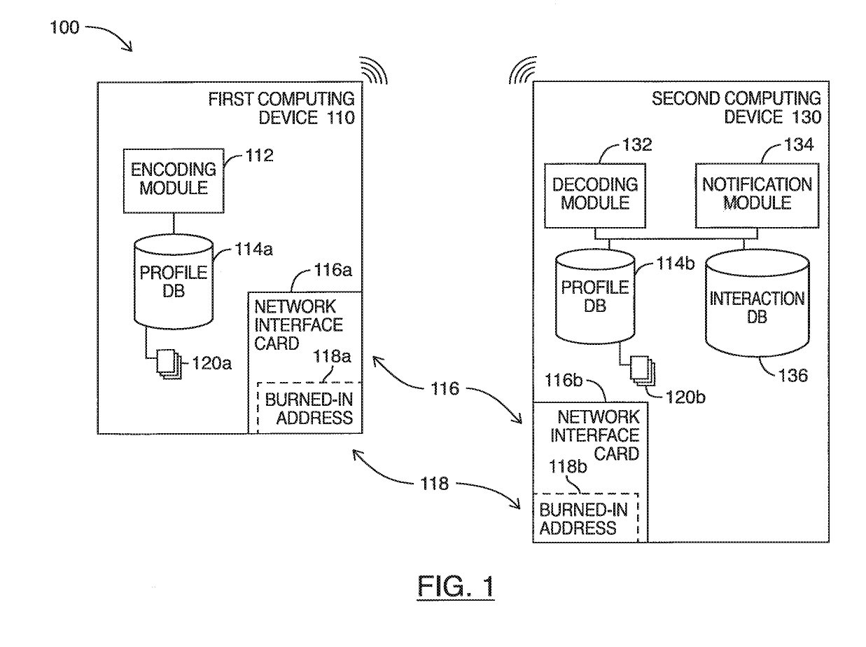

Referring to FIG. 1, shown there generally as 100 is a block diagram of a system for announcing device communication availability, in accordance with at least one embodiment of the present invention. The system 100 may include a first computing device 110 that is in physical proximity to a second computing device 130. At a high-level, the system 100 operates by having the first computing device 110 encode profile information into a data link layer address (e.g., a Medium Access Control (MAC) address, also known as a Media Access Control address) of an announcement message. Upon receipt of the announcement message, the second computing device 130 decodes the data link layer address to extract the profile information, and uses the extracted profile information to determine if the first computing device 110 is suitable for communication with the second computing device 130.

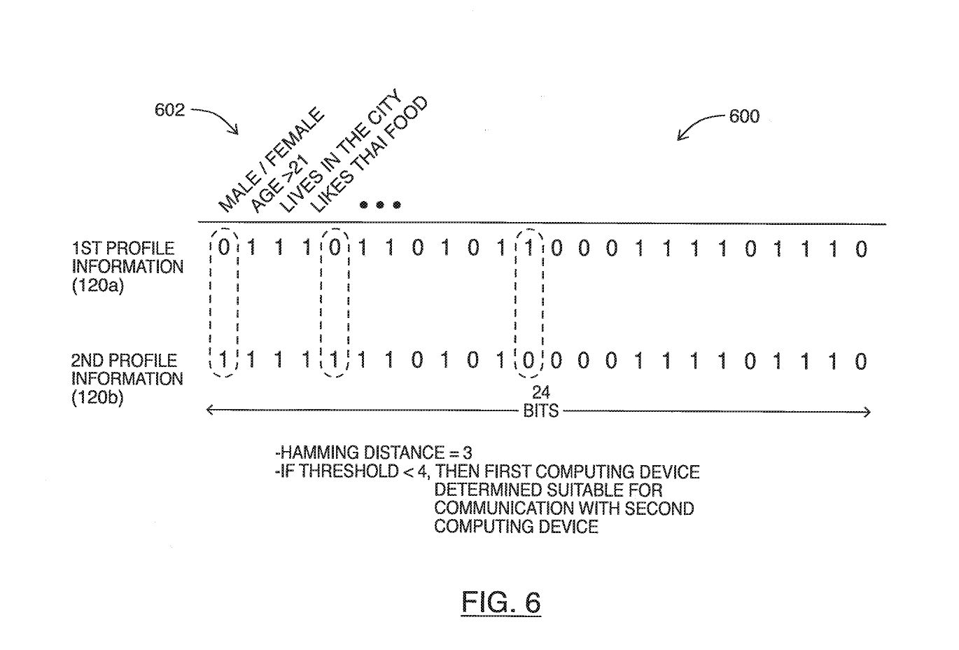

The first computing device 110 may include an encoding module 112 to perform the encoding of the profile information 120a into the data link layer address. The first computing device 110 may also include a profile database 114a for storing the profile information 120a. As discussed in greater detail below in relation to FIGS. 6 and 10-11, the profile information may include answers to a survey that is presented at the first computing device 110.

As used herein, the term “data link layer address” refers to a device address used in the data link layer (layer 2) of the Open Systems Interconnection (OSI) model for communication amongst computing devices. As will be understood by persons skilled in the art, the model contains seven layers: the physical layer (layer 1), the data link layer (layer 2), the network layer (layer 3), the transport layer (layer 4), the session layer (layer 5), the presentation layer (layer 6), and the application layer (layer 7).

The different layers are designed for particular purposes to achieve interoperation in communications amongst devices. For example, in traditional applications that allow for communication between users of computing devices (e.g., chat or dating applications), profile information may be provided in the application layer (layer 7) of a message when a given user selects to view the profile of another user. While the data link layer (layer 2) is typically designed to establish a protocol for achieving reliable transmission of data frames between two nodes connected by a physical layer (e.g., by detecting and correcting errors that may occur in the physical layer, or controlling the rate of data transmission between two nodes), the present embodiments encode profile information that is normally provided in a higher layer (e.g., layer 7) into a device address that is communicated at the data link layer.

Examples of data link layer addresses in which profile information may be encoded include MAC addresses that are used with Institute of Electrical and Electronics Engineers (IEEE) 802 standards such as 802.3 (Ethernet) or 802.11 (Wi-Fi). Other examples of data link layer addresses include BD_ADDR addresses as used with the Bluetooth™ protocol managed by the Bluetooth Special Interest Group (SIG).

The first computing device 110 may have a Network Interface Card (NIC) 116a that allows the first computing device 110 to connect to a computer network. The NIC 116a of the first computing device 110 may have a burned-in address (BIA) 118a at the data link layer that is assigned to it by the manufacturer of the NIC 116a. The address is “burned-in” in the sense that it may be stored in the NIC's 116a read-only memory (ROM) or some firmware mechanism. The BIA may also be known as a hardware address or a physical address. In various embodiments, the encoding module 112 may encode the profile information into a temporary address that overwrites the BIA that would normally be encoded into the data link layer address field of a given message. Since the BIA is burned-in, the address will remain intact despite the temporary overwriting—a reboot of the computing device 110 can restore the BIA.

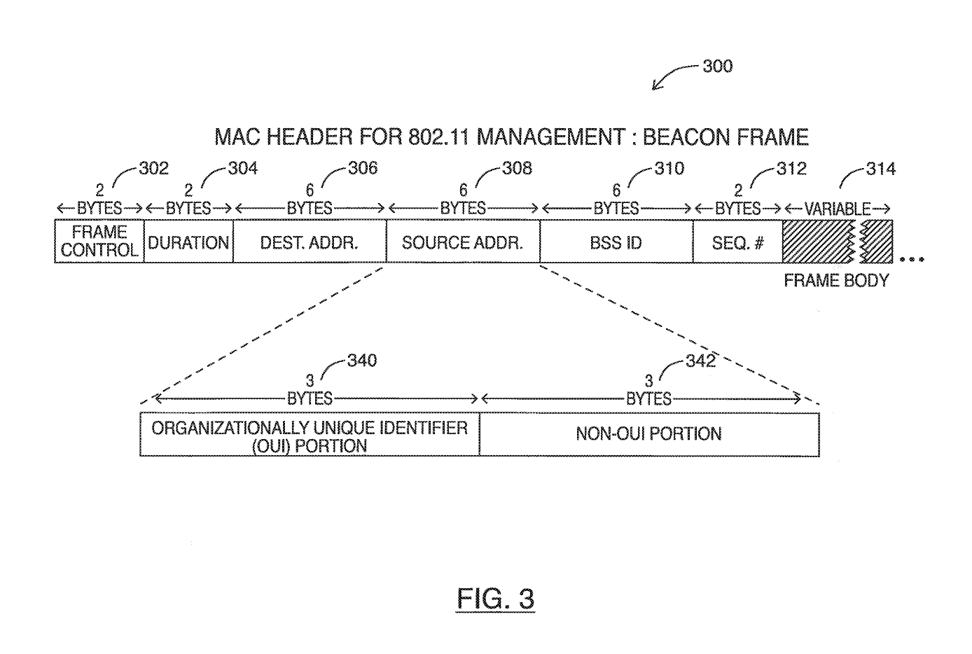

As discussed in greater detail below in relation to FIGS. 3-5, the data link layer address may include two portions: (i) a portion that encodes an Organizationally Unique Identifier (OUI) (e.g., the manufacturer's registered identification number as assigned by the IEEE), and (ii) a non-OUI portion that is to be assigned by the organization associated with the OUI. Also discussed below, MAC addresses may also have different standardized lengths: e.g., the IEEE-defined Extended Unique Identifier-48 (EUI-48) format has 48-bits, whereas the EUI-64 format has 64 bits. In various embodiments, the encoding module 112 may encode the profile information into the non-OUI portion of a temporary MAC address (which length may vary depending on the particular format of the data link layer address).

The second computing device 130 may include a decoding module 132 and a notification module 134 that are in connection with a profile database 114b and an interaction database 136. Upon receiving an announcement message from a first computing device 110, the decoding module 132 at the second computing device 130 may be configured to decode the data link layer address stored in the address field of the announcement message and extract the profile information 120a from the first computing device 110 stored therein. As discussed in greater detail below, the decoding module 132 may then proceed to compare the extracted profile information 120a against profile information 120b stored at the second computing device 130 to determine whether the first computing device 110 is suitable for communication with the second computing device 130.

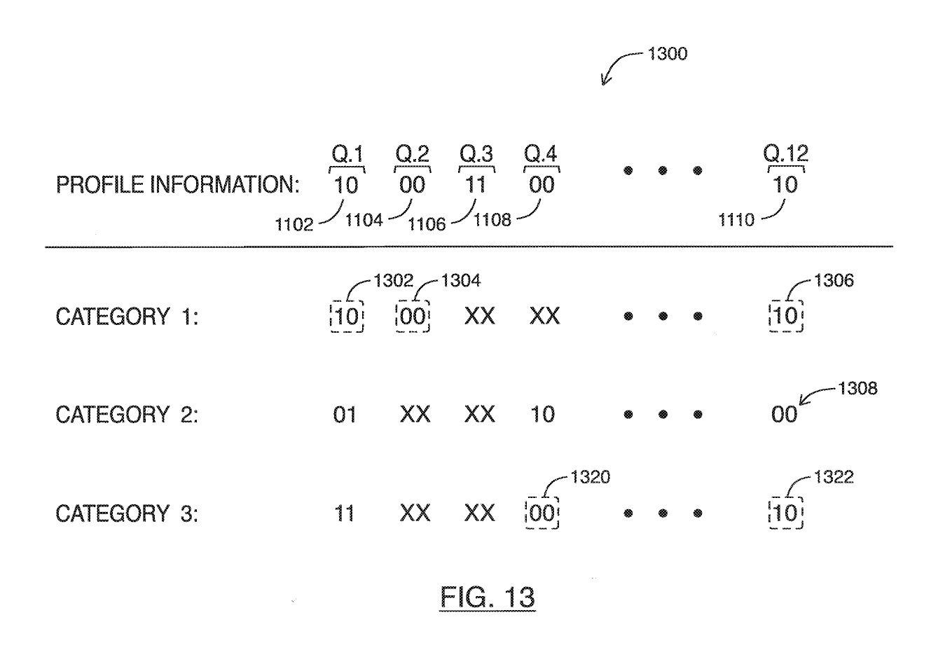

The profile information 120b stored at the second computing device 130 may be stored in the profile database 114b, which may be configured in a manner similar to the corresponding profile database 114a that stores profile information 120a at the first computing device 110. To allow for an effective comparison between the first profile information 120a received from the first computing device 110 and the second profile information 120b stored at the second computing device 130, the second profile information 120b may be encoded into a binary string that matches the format of the first profile information 120a extracted from the announcement message. As discussed below in relation to FIGS. 6 and 13, the comparison may then involve calculating the positions in the strings where the respective encoded profile information are different

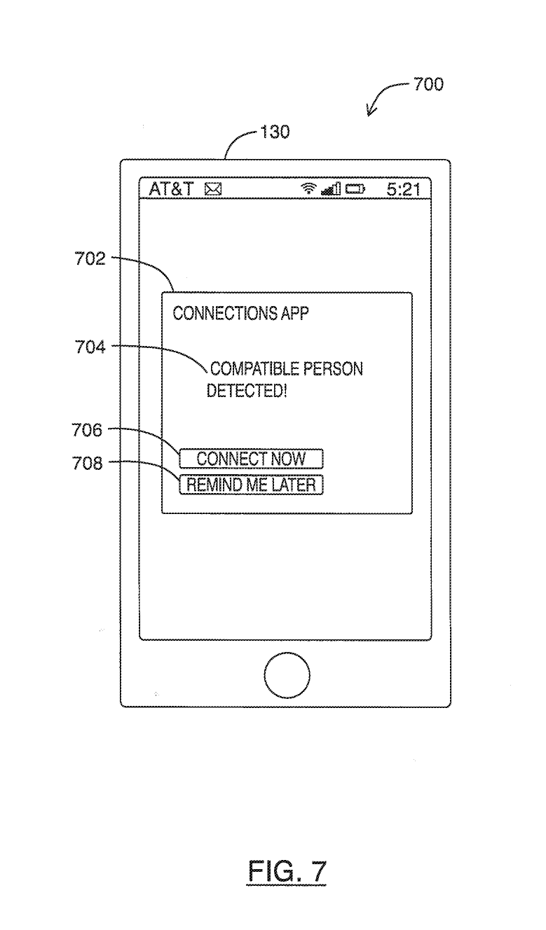

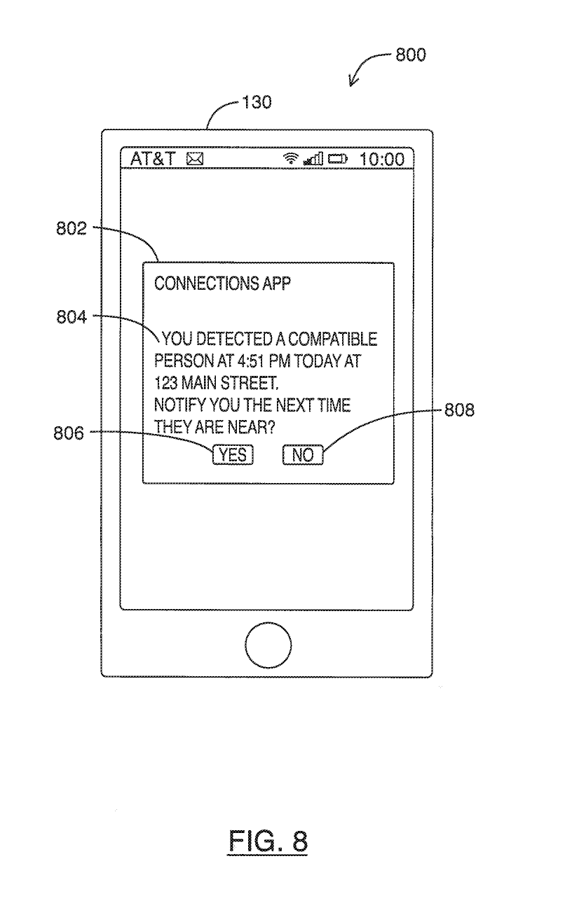

If the comparison between the first profile information 120a and the second profile information 120b results in a determination that the first computing device 110 and the second computing device 130 are suitable for communication, then the second computing device 130 may output a notification on the second computing device 130. Additionally or alternatively, it may store information about the received announcement message in the interaction database 136 so that it may be subsequently read at a future time to output a notification then. Examples of user interfaces that may be shown to output notifications are discussed below in relation to FIGS. 7 and 8.

As used herein, a notification to inform a user of the second computing device 130 that a first computing device 110 is physically proximate and may be suitable for communication is called a “nudge”. In various embodiments, a nudge may include one or more of: an audible sound being played, a message being displayed, a vibration being triggered, a message being sent to a wearable device connected to the second computing device 130, any other notification mechanism that may be provided by the second computing device 130, or any combination of the foregoing.

While the decoding module 132 and the notification module 134 are illustrated and discussed in FIG. 1 as separate modules, it will be appreciated that in alternate embodiments, the functionality provided by the different modules may be combined together into a single module or further separated into more than the described two modules, depending on the nature of the implementation. Similarly, although the profile database 114b and interaction database 136 in the second computing device 130 are described and illustrated as being stored in distinct and separate databases, in alternate embodiments, the different types of data may be stored together.

Moreover, although the encoding components (e.g., encoding module 112) and decoding components (e.g., decoding module 132, notification module 134, and interaction database 136) are shown in FIG. 1 as being provided separately on the first computing device 110 and the second computing device 130 respectively, in various embodiments, a given computing device may be configured to perform both encoding and decoding steps.

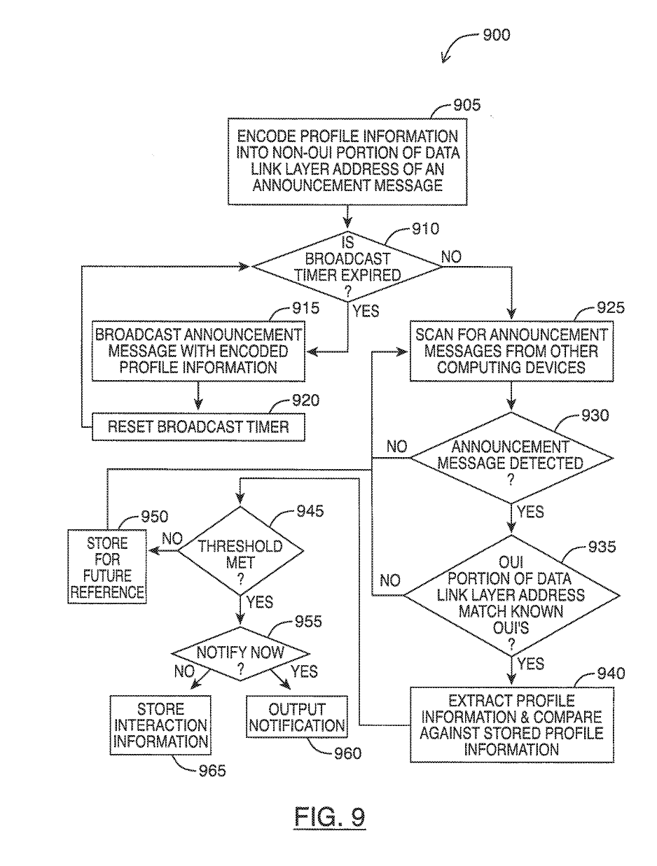

For example, in various embodiments, the second computing device 130 may itself be configured to broadcast announcement messages encoding its profile information 120b to other computing devices. In such environments, the second computing device 130 may itself have a NIC 116b and corresponding BIA 118b for connecting to a computer network. The second profile information 120b may then be encoded into a temporary data link layer address. A flowchart describing steps performed by a computing device that is configured to perform both encoding and decoding steps for respectively announcing and discovering neighboring computing devices suitable for communication is discussed below in relation to FIG. 9. In such embodiments, the encoding module 112 and the decoding module 132 need not be implemented separately, but instead, may be collectively implemented in a single programmatic module.

The first and second computing devices 110, 130 may be various programmable computing devices (examples of which were noted above). The encoding module 112, decoding module 132, and notification module 134 may be implemented using suitable programming platforms available on the operating systems of the first computing device 110 and second computing device 130. For example, in UNIX-based operating systems (e.g., Ubuntu or Apple™'s OS X™ and iOS™ operating systems), suitable programming tools may be used to build an application that uses a NIC 116 to communicate. Such system may overwrite a BIA with a temporary MAC address having encoded profile information by using a variety of different commands available on different operating systems (which, in some situations, may require the user to have root access before the command is allowed to be executed). For example, in the Apple™ OS X™ and iOS™ environments, the command “su nvram wifiaddr=XX:XX:XX:XX:XX:XX” may be used to modify the MAC address, where “XX:XX:XX:XX:XX:XX” is to be filled in with the desired MAC address. In another example, in the Linux™ operating system, the following commands may be executed in sequence (with the square brackets representing the information to be filled in):

# ifconfig [interface name] down

# ifconfig [interface name] hw ether [new MAC address]

# ifconfig [interface name] up

Using these commands, changing the MAC address of an NIC named “eth0” to the address “1A:2B:3C:4D:5E:6F” would involve executing:

# ifconfig eth0 down

# ifconfig eth0 hw ether 1A:2B:3C:4D:5E:6F

# ifconfig eth0 up

As will be understood by persons skilled in the art, other commands or programs to modify MAC addresses are, or may be made available, on different operating systems. All such methods of modifying MAC addresses are within the contemplation of the present disclosure. For example, an article entitled “How To Change MAC Address in Linux, BSD, Unix” dated Apr. 26, 2010 available at <http://blog.up-link.ro/how-to-change-mac-address-in-linux-bsd-unix/> lists various commands that may be used to modify a device's MAC address on various UNIX-based operating systems. The entire contents of such article are incorporated herein by reference.

Various types of database technologies (e.g., MySQL) may be used to provide the database(s) described herein. Alternatively, instead of a database being provided, other ways of persistent storage may be used (e.g., a file and folder structure). As will be understood by a person skilled in the art, variations in the technologies used to implement the described inventions may be possible.

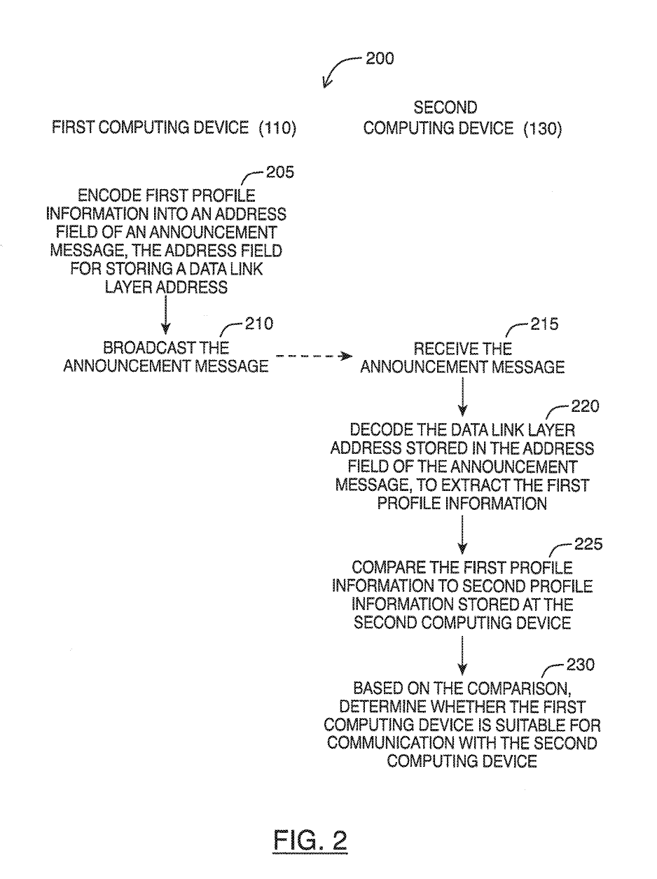

Referring to FIG. 2, shown there generally as 200 is a flowchart diagram illustrating steps performed by a first computing device 110 and a second computing device 130 in a system for announcing device communication availability, in accordance with at least one embodiment of the present invention. In describing the steps of FIG. 2, reference will simultaneously be made to the various components shown in FIG. 1 and message format diagrams of FIGS. 3-5. As illustrated, FIG. 2 shows the interactions between the first computing device 110 and the second computing 130. In some embodiments, the steps described as being performed by the first computing device 110 may be performed by a processor provided on the first computing device 110, executing the encoding module 112. Similarly, the steps described as being performed by the second computing device 130 may be performed by a processor provided on the second computing 130, executing the decoding module 132 and/or the notification module 134.

Encoding Profile Information into a Data Link Layer Address

Referring to FIG. 2, at step 205, the first computing device 110 may encode first profile information into an announcement message. The announcement message may include an address field for storing a data link layer address, and the first profile information can be encoded into the data link layer address stored in the address field. In various embodiments, the announcement message may be a beacon frame of the IEEE 802.11 Wi-Fi standard. As will be understood by persons skilled in the art, the beacon frame in the 802.11 standard is one of the management frames in an IEEE 802.11 based Wireless Local Area Network (WLAN). The frame contains information about a given WLAN, and may be transmitted periodically to announce its presence. In some situations, beacon frames are transmitted by an Access Point (AP) providing access to a WLAN.

Many computing devices have Wi-Fi capability, and are configured to scan for beacon frames to detect the presence of available WLANs to which the devices can connect. In some embodiments, transmitting a beacon frame as the announcement message may allow a given first computing device 110 broadcasting the announcement message to reach a large number of second computing devices 130 that are already configured to listen for such beacon frames.

Referring simultaneously to FIG. 3, shown there generally as 300 is a diagram illustrating the format of an 802.11 beacon frame having a data link layer address in which profile information may be encoded, in accordance with at least one embodiment of the present invention. As noted, the beacon frame is a type of management frame in the 802.11 protocol, and management frames may have a MAC header consisting of the elements shown. In particular, the MAC header may have a frame control field 302 (2 bytes), a duration field 304 (2 bytes), a destination address field 306 (6 bytes), a source address field 308 (6 bytes), a basic service set identifier or BSSID field 310 (6 bytes) and a sequence number field 312. The frame body 314 portion of the beacon frame may be a variable number of bytes in length, and may include other data fields that are typically used for the announcement of the availability of a WLAN. These fields (not shown) may be for the following: a timestamp, beacon interval, capability information, Service Set Identification (SSID), supported rates, frequency-hopping (FH) parameter set, Direct-Sequence (DS) Parameter Set, Contention-Free (CF) Parameter Set, Independent Basic Service Set (IBSS) Parameter Set, and Traffic Indication Map (TIM).

To indicate that a given announcement message is to be broadcasted, a MAC address consisting of all ‘1’s (e.g., in hexadecimal, FF:FF:FF:FF:FF:FF) can be encoded into the destination address field 306 of the MAC header of the beacon frame. However, instead of encoding a BIA 118a of the NIC 116a at the first computing device 110 (as shown in FIG. 1), the encoding module 112 may encode profile information 120a into the source address field 308 of the MAC header in the beacon frame.

As noted above, a MAC address may have an OUI portion and a non-OUI portion. This is shown in FIG. 3 in an expanded view of the temporary MAC address that can be encoded into the source address field 308 of the MAC header. As illustrated, the OUI portion 340 may be 3 bytes and the non-OUI portion 342 may be 3 bytes (or 24 bits). The first profile information 120a may be encoded into the 24 bits available in the non-OUI portion 342 of the temporary MAC address.

By encoding the profile information into the non-OUI portion 342 of a temporary MAC address, the resultant MAC address would appear indistinguishable from a randomly assigned non-OUI portion of a MAC address. This may allow regular processing of the encoded MAC address and beacon frame by software that regularly processes such announcement messages (e.g., system software of a computing device that provides networking capabilities).

As shown in FIG. 3, the fields of the MAC header that can store MAC addresses are all being shown as storing MAC addresses in the EUI-48 (6-byte) format. However, it will be understood that the embodiments described herein may be practiced with MAC addresses of the EUI-64 (8-byte) format also.

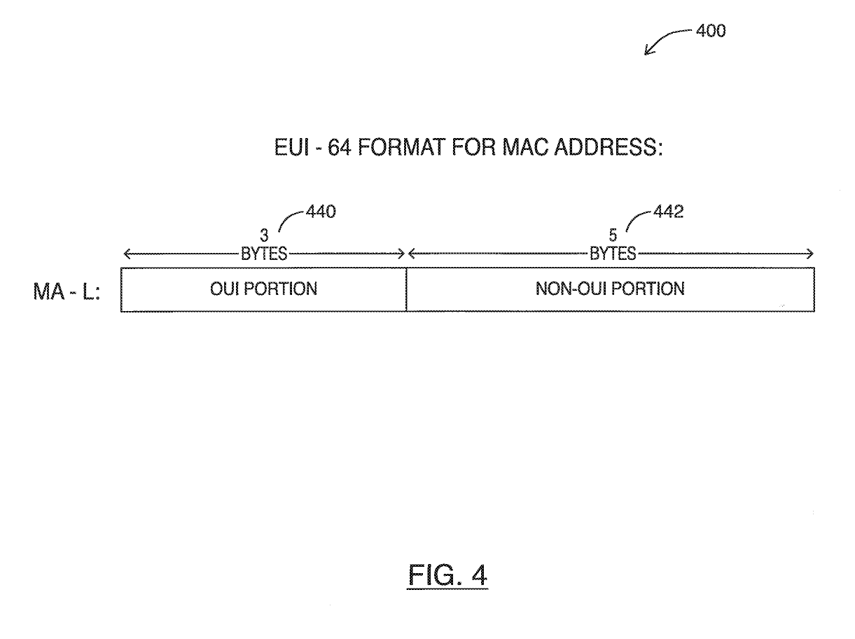

Referring to FIG. 4, shown there generally as 400 is a format of a 64-bit MAC address in which profile information may be encoded, in accordance with at least one embodiment of the present invention. In the EUI-64 format with 64 bits, the OUI portion 440 may still be 3-bytes, but the remaining non-OUI portion 442 may be longer and have 5 bytes (or 40 bits) which can be used in the same manner that the 24-bit non-OUI portion of a EUI-48 MAC address is used (e.g., for encoding profile information).

As will be understood by persons skilled in the art, each of the EUI-48 and EUI-64 formats for MAC addresses may be assigned by the IEEE from different registries: MAC address block large (MA-L), MAC address block medium (MA-M), and MAC address block small (MA-S). In the case of MA-L addresses, the OUI value is 24 bits, and the remainder of the address (24-bits in the case of EUI-48 and 40 bits in the case of EUI-64) can be allocated by the entity who purchased the OUI.

As illustrated in FIGS. 3 and 4, a MA-L EUI-48 MAC address and a MA-L EUI-64 MAC address are shown respectively. However, the present embodiments may also be practised with MA-S and MA-M MAC addresses. MA-M MAC addresses have a 28-bit value assigned by the IEEE Registration Authority (RA), with the remainder of the address (20 bits for a EUI-48 address and 36 bits for a EUI-64 address) being allocated by the organization who purchased the MA-M address block. Similarly, MA-S addresses have a 36-bit value assigned by the IEEE Registration Authority, with the remainder of the address (12 bits for a EUI-48 address and 28 bits for a EUI-64 address) being allocated by the organization who purchased the MA-S address block. The present embodiments may be practised with MA-M and MA-S addresses if, for example, the profile information is encoded into the remaining portions of the addresses not filled with the IEEE RA-assigned values.

Although the term “OUI” is generally used by the IEEE to refer to MA-L MAC addresses, as used herein, references to the “OUI portion” of a MAC address may refer to any portion of a MAC address that stores a IEEE RA-assigned value (including the 28-bit value for MA-M MAC addresses and the 36-bit value for MA-S MAC addresses). Correspondingly, the “non-OUI portion” of a MAC address may refer to any remaining portion of a MAC address that does not store the IEEE RA-assigned value (including the portions of the address appended to the 28-bit value for a MA-M MAC address and the 36-bit value for a MA-S MAC address).

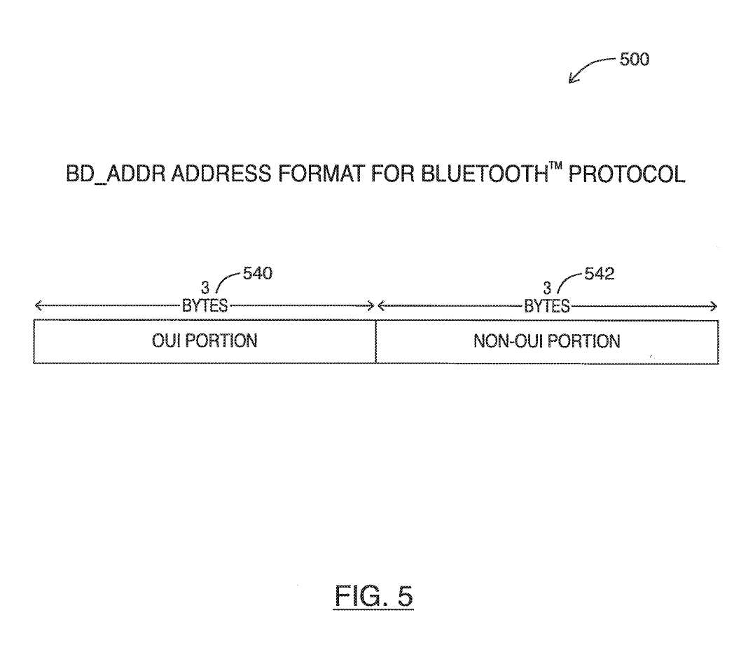

Referring to FIG. 5, shown there generally as 500 is a format of a data link layer address for use with the Bluetooth™ protocol, in which profile information may be encoded, in accordance with at least one embodiment of the present invention. In some embodiments, instead of encoding the profile information 120a at the first computing device 110 into a MAC address, the profile information 120a may be encoded into a BD_ADDR address used with the Bluetooth™ protocol. As will be understood by persons skilled in the art, the Bluetooth™ protocol is designed for shorter range radio links between computing devices. Computing devices enabled to communicate using the Bluetooth™ protocol may have a unique BD_ADDR address assigned to it. As with MAC addresses, the BD_ADDR address may have two portions: an OUI portion 540 (3 bytes) to store a manufacturer-unique identifier assigned by the IEEE, and a non-OUI portion 542 (3 bytes) to store values allocated by a given organization. As with MAC addresses, profile information 120a may be encoded into the non-OUI portion 542 of the BD_ADDR address. A temporary BD_ADDR address having such encoded information may then be used in announcement messages that establish Bluetooth™ connections between computing devices. For example, such announcement messages may be Bluetooth™ packets that allow for a computing device to be “discoverable” by another computing device under the Bluetooth™ protocol. In various embodiments, these Bluetooth™ packets that allow for device discoverability may also be considered “beacon” frames.

In some Bluetooth™ implementations, the data link layer address is stored as plain text in a designated file available on the file system of the Bluetooth™-enabled computing device. This address may be read when the computing device's Bluetooth™ data link layer address is required. In such embodiments, the encoding of profile information into the Bluetooth™ data link layer address may be performed by modifying the file to include the profile information. For example, this may involve copying the original Bluetooth™ data link layer address to another file or location, and temporarily overwriting the original Bluetooth™ data link layer address contained in the file with an address having encoded profile information, prior to the data link layer address being read by system software typically performing Bluetooth™ communications operations. In some embodiments, after the Bluetooth™ operation has been performed, the original Bluetooth™ data link layer address may be restored and re-written to the file.

Referring back to FIG. 2, after having encoded first profile information 120a into an announcement message, at step 210, the first computing device 110 broadcasts the announcement message (e.g., using the NIC 116a).

### Decoding the Data Link Layer Address to Extract Profile Information, and Comparing the Extracted Profile Information to Stored Profile Information

Referring still to FIG. 2, at step 215, the announcement message may be received at the second computing device 130. As noted above, in embodiments where the announcement message is a beacon frame used in the 802.11 Wi-Fi standard, the second computing device 130 may already be configured to scan for such announcement messages when scanning for the availability of nearby WLANs.

At step 220, the second computing device 130 may decode the data link layer address stored in the address field of the announcement message, to extract the first profile information. As noted, the data link layer address may include an OUI-portion and a non-OUI portion where the OUI portion stores a IEEE-assigned unique identifier for an organization. Thus, to employ the present embodiments, it may be possible to purchase a block of addresses from the IEEE, encode the assigned OUI into the OUI portion of a MAC address field in the announcement message (e.g., as discussed above, this may be the source address field of a MAC header of a beacon frame), and use the assigned OUI as an indication to other computing devices that profile information may be encoded in the non-OUI portion of the address. Additionally or alternatively, instead of explicitly purchasing a block of addresses from the IEEE for this purpose, it may be possible to repurpose an already-assigned block of addresses. For example, this may involving using the OUI associated with such block of already-assigned addresses to indicate that profile information may be encoded into the non-OUI portion of addresses having such OUI.

In such case, prior to decoding the data link layer address stored in the address field of the announcement message to extract the first profile information 120a, the second computing device 130 may first: (i) read the OUI portion of the data link layer address, and (ii) compare the OUI portion of the data link layer address to stored OUIs already known to be associated with computing devices that perform the encoding of profile information in the manner described above. For example, in situations where a given computing device is configured to perform both encoding and decoding steps (e.g., as discussed below in FIG. 9), a device will be in possession of the OUI it uses to indicate to other computing devices that it is encoding profile information into MAC addresses. Thus, if such computing device receives an announcement message from another computing device, it may read the OUI portion of a MAC address encoded therein, and compare it with the one it uses itself.

If the read OUI and the stored OUI match, then the computing device 130 may know that the received announcement message originated from an application executing the encoding module 112 (as shown in FIG. 1), and that profile information may be encoded in the non-OUI portion of the MAC address. The computing device may then proceed with the decoding of the MAC address to extract the profile information. After extracting the first profile information 120a from the MAC address, the method may proceed to step 225.

At step 225, the second computing device 130 may compare the extracted first profile information 120a to second profile information 120b stored at the second computing device 130. In various embodiments, the first profile information 120a may be answers to questions of a survey that have been encoded into the available bits (e.g., in the non-OUI portion) of the data link layer address.

In a simple example, the questions may require binary (e.g., yes/no) answers, and each answer may be encoded into an available bit of the non-OUI portion of the data link layer address. The second profile information 120b used to compare against the first profile information 120a may then be answers to the same questions. To allow for ease of comparison with the encoded answers of the first profile information 120a, the second profile information 120b may also be encoded into a binary string of the same length as that storing the encoded first profile information 120a.

Referring simultaneously to FIG. 6, shown there generally as 600 is a comparison between first profile information 120a extracted from a data link layer address and second profile information 120b, where the first and second profile information are respective answers to binary questions, in accordance with at least one embodiment of the present invention. As shown, the first profile information 120a are answers to binary questions 602, which are encoded into a 24-bit binary string that may be stored in a non-OUI portion of a MA-L EUI-48 MAC address. For example, the questions shown are: the gender of a user of the first computing device 110, whether the age of the user is greater than 21, whether the user lives in the city, and whether the user likes Thai food. As the answers to these questions all require binary answers, each bit in the first profile information may correspond to an answer to a given question. The second profile information 120b may contain answers to the same questions and be encoded in a similar fashion.

When comparing the first profile information 120a to the second profile information 120b, the second computing device 130 may calculate a hamming distance between the two binary strings (e.g., between (i) the bits of the data link layer address having the encoded first answers that form the first profile information 120a and (ii) the binary string having the encoded second answers that form the second profile information 120b). As will be understood by persons skilled in the art, the hamming distance between two strings of equal length is the number of positions between the two strings that are different. In the example shown in FIG. 6, the positions where there are differences between the first profile information 120a string and the second profile information 120b string are shown with dotted outline. As there are three positions where there are differences, the hamming distance would be ‘3’.

Referring back to FIG. 2, at step 230, the second computing device 130 may determine, based on the comparison performed at step 225, whether the first computing device 110 is suitable for communication with the second computing device 130. For example, in embodiments where the two sets of profile information 120a, 120b are answers to questions that require binary answers, this determination may involve comparing the calculated hamming distance against a threshold number, such that if the hamming distance is less than the threshold number (e.g., the differences between the answer sets to the binary questions are small, and the similarities are many), the first computing device 110 may be determined to be suitable for communication with the second computing device 130. As shown in FIG. 6, a threshold number may be set to ‘4’, such that if the hamming distance is ‘1’, ‘2’, or ‘3’, then it would mean that the first profile information 120a and the second profile information 120b have at least ‘21’ answers in common (e.g., in the case of the profile information being encoded in a 24-bit non-OUI portion of MA-L EUI-48 MAC addresses) or 37 answers in common (in the case of the profile information being encoded in a 40-bit non-OUI portion of a MA-L EUI-64 MAC addresses). Such high commonality in the answers to the survey may indicate that the user of the first computing device 110 and the user of the second computing device 130 have many interests in common and that the two users would be suitable for communicating with each other.

The threshold number may be calibrated depending on the desired degree of compatibility that the user of the second computing device 130 desires before a given first computing device 110 is determined to be suitable for communication. For example, a lower threshold number would mean there is a higher number of common answers and likely a higher degree of compatibility. However, such a high threshold may result in a lower number of compatible matches. The threshold number may thus be calibrated to be lower to reduce the amount of compatibility, but increase the number of compatible first computing devices 110 located.

Referring still to FIG. 2, in various embodiments, step 230 may involve the second computing device 130 determining that the first computing device 110 is not suitable for communication with it. In some such embodiments, the determination may be a result of the first profile information 120a not satisfying the profile-similarity criteria as it relates to the second profile information 120b. However, additionally or alternatively, the determination may be a result of a determination that the two sets of profile information 120a, 120b are sufficiently dissimilar so as to eliminate the first computing device 110 as a computing device with which communication is suitable.

For example, in the example above where the two sets of profile information 120a, 120b are answers to binary questions encoded into individual bits of respective two binary strings, the threshold number for the hamming distance may also be used for this purpose. For example, while the total number of questions (e.g., ‘24’ questions for a 24-bit non-OUI portion of MA-L EUI-48 MAC addresses, as noted) minus the threshold number for the hamming distance may represent the minimum number of similar answers that are required before a matching first computing device 110 is located, inversely, the threshold number for the hamming distance may also represent the maximum number of different answers that will be tolerated before a first computing device 110 is eliminated from being considered to be suitable for communication with the second computing device 130.

Further variations may be possible. For example, the second computing device 130 may be configured to select certain questions in the survey for which the first profile information 120a must have a desired answer (either matching or another acceptable answer), while indicating answers to certain other questions may not be as important and therefore, a requirement on an acceptable answer may not be stated.

Notifying Users Upon a Determination that a First Computing Device is Suitable for Communication with the Second Computing Device

Upon the second computing device 130 determining that the first computing device 110 is suitable for communication therewith, the second computing device 130 may respond in different ways. For example, in some embodiments, the second computing device 130 may immediately output a notification.

Referring to FIG. 7, shown there generally as 700 is an example user interface that may be outputted at a second computing device if it is determined that a first computing device is suitable for communication with a second computing device, in accordance with at least one embodiment of the present invention. In describing FIG. 7, reference will also be made to the components of FIG. 1. As illustrated, the second computing device 130 is shown as a smartphone device or tablet computer with a touchscreen display configured to execute a “Connections App” that is configured to incorporate the functionality of the decoding module 132 and notification module 134 of FIG. 1. In this example, upon the “Connections App” determining that a first computing device 110 suitable for communication has been located, it may display a popup 702 with a message 704 indicating “Compatible Person Detected!” The popup 702 may also provide user interface control options to “Connect Now” 706 or “Remind Me Later” 708.

If the user selects the “Connect Now” 706 option, the second computing device 130 may transmit a signal to the first computing device 110 to request initiation of a network communication. The network communication requested to be initiated by the second computing device 130 may be any means for establishing communication between the first computing device 110 and the second computing device 130. For example, in some embodiments, the network communication may be a network connection configured according to an Ad-Hoc mode of the IEEE 802.11 Wi-Fi standard. Additionally or alternatively, the network connection requested to be initiated may be a mesh network.

Referring still to FIG. 7, if the option 708 to remind the user later is selected, then the second computing device 130 may record interaction information about the announcement message received from the first computing device 110. In various embodiments, the interaction information that is recorded may include: location information of where the second computing device 130 received the announcement message (e.g., such geographic information may include: longitude and latitude information, a city identifier, a postal code or zip code, a neighborhood identifier, a country or any combination of the foregoing), a timestamp indicating when the second computing device 130 received the announcement message, the data link layer address stored in an address field of the announcement message (e.g., the MAC address from which the first profile information 120a was extracted), the second profile information 120b stored at the second computing device 130, and/or other analogous information that may assist the user of the second computing device 130 in recalling details of the interaction with the first computing device 110. The interaction information may be recorded in the interaction database 136 by the notification module 134.

After having stored the interaction information into the interaction database 136 at the time when the interaction with the first computing device 110 occurred, at some later time, the notification module 134 may be configured to read the interaction information and output a reminder notification that the first computing device 110 had been determined to be suitable for communication.

Referring to FIG. 8, shown there generally as 800 is an example user interface that may be shown at a second computing device 130 to remind a user of the second computing device 130 that a first computing device 110 had previously been determined to be suitable for communication, in accordance with at least one embodiment of the present invention. In describing FIG. 8, reference will also be made to the components of FIG. 1. As illustrated in FIG. 8, a popup 802 may be outputted by the “Connections App” discussed above, which incorporates functionality of the notification module 134. The message shown in the popup 802 may include the stored interaction information such as the time and location of where the announcement message from the first computing device 110 was detected. For example, as illustrated in FIG. 8, the message shows “You detected a compatible person at 4:51 pm today at 123 Main Street.” As shown, the message also asks the user whether they would like to be notified the next time the same first computing device 110 is nearby, and options for responding ‘YES’ 806 or ‘NO’ 808 to the question are presented. The second computing device 130 may accordingly record the answer to this question upon one of the two buttons being selected. If the answer is ‘YES’, the second computing device 130 may output a notification at the second computing device 130 if the second computing device 130 interacts with the same first computing device 110 again at a later time.

FIGS. 7 and 8 show particular examples of how the second computing device 130 may output notifications indicating that a first computing device 110 suitable for communication has been detected. However, variations to the above example implementations are possible. For example, as described above, interaction information is stored upon selection of a user interface control 708 on a user interface 700 that is displayed immediately upon detection of the first computing device 110. However, in other embodiments, the “Connections App” may be provided with a setting that allows the user to select to immediately store the interaction information upon detection of the first computing device 110, without displaying a prompt to select to do so when the first computing device 110 is detected.

Additionally or alternatively, the second computing device 130 may be configured to perform statistical analyses of the interaction information stored in the interaction database 136. For example, this may be performed to determine the geographical locations where the second computing device 130 is commonly at that have the most “like-minded” people who are suitable for communication with the user of the second computing device 130. Information about such geographical information may then be outputted at the second computing device 130 to show a user of the second computing device 130 where the user is likely to find “like-minded” people that they would like to meet. In another example, the statistical analyses may be performed to reveal how frequently a compatible first computing device 110 is within proximity of the second computing device 130.

In various embodiments, the results of these statistical analyses may be used by the second computing device 130 in determining whether or not to output a notification at the second computing device 130. For example, the second computing device 130 may be configured to only output a notification if a given compatible first computing device 110 has been detected a threshold number of times (e.g., indicating that the first computing device 110 and the second computing device 130 are frequently in the same geographical location).

Example Embodiment where a Single Device Performs Both Encoding and Decoding

As discussed above, although the embodiments illustrated in FIGS. 1 and 2 have the encoding, decoding, comparison, and notifying steps divided between a first computing device 110 and a second computing device 130, in some embodiments, a single computing device may be configured to perform all such steps.

Referring to FIG. 9, shown there generally as 900 is a flowchart diagram illustrating steps performed by a computing device configured to encode profile information and scan for neighboring computing devices that are suitable for communication, in accordance with at least one embodiment of the present invention.

At step 905, the computing device may encode profile information into a non-OUI portion of a data link layer address of an announcement message. This step may be performed in a manner similar to what is described above in relation to step 205 of FIG. 2.

At step 910, the computing device may check whether a broadcast timer is expired. If it has, the method may proceed to step 915. For example, a broadcast timer may be provided in the computing device to determine how frequently the announcement message is to be broadcasted. In various examples, this timer may be the timer used to determine how frequently the beacon frame in the IEEE 802.11 protocol should be transmitted. If the timer has expired, the method may proceed to step 915 and the computing device may broadcast the announcement message with profile information encoded therein. At step 920, the computing device may reset the broadcast timer, and the method may return to step 910.

If it is determined that the broadcast timer has not expired, the method may proceed to step 925. At step 925, the computing device may scan for announcement messages from other computing devices. As discussed above in relation to FIG. 2, in the situation where the announcement message is a beacon frame used in the IEEE 802.11 Wi-Fi standard, the computing device may be configured to scan for such messages to detect available WLANs.

At step 930, the computing device determines whether an announcement message has been detected. If not, the method returns to step 925. If an announcement message has been detected, the method proceeds to step 935.

Step 935 involves determining whether an OUI portion of a data link layer address in the announcement message matches an OUI known to be associated with computing devices that encode profile information into data link layer addresses. This may be performed in accordance with step 220 discussed above in the method of FIG. 2. If the OUI portion of the data link layer address does not match known OUI information, the method may return to step 925 and continue to scan for other announcement messages. However, if a match is determined, the method may proceed to step 940.

At step 940, the computing device may extract profile information from a data link layer address of the announcement message and compare it against stored profile information. These steps may be performed in a manner similar to what is discussed above in relation to steps 220 and 225 of FIG. 2.

At step 945, the computing device may determine whether the comparison results in a threshold being met. For example, as discussed above in relation to step 230 of FIG. 2, the threshold may be a minimum hamming distance between two binary strings that must not be exceeded. If the threshold is not met, the method may proceed to step 950 and store the MAC address from the received announcement message for future reference. Storing the MAC address at this point may allow for increased speed in processing announcement messages from the same computing device at a later time. This is because the stored information may allow the same announcement messages to be recognized (and dismissed) immediately upon receipt without having to perform a number of additional steps to determine that computing device from which the announcement message was received is not suitable for communication (e.g., reading the OUI portion of the data link layer address, extracting the profile information, and comparing it with the stored profile information). After step 950, the method may proceed back to step 925 and scan for additional announcement messages.

If the threshold is met at step 945, the method may proceed to step 955 to determine whether the computing device should immediately notify the user that a communication-compatible device has been located. As discussed above in relation to FIGS. 7 and 8, such determination may be made based on a setting for an application (e.g., a “Connections App”) encompassing the encoding and decoding steps discussed herein. Also as discussed above, if the result of step 955 is that a notification should be outputted at the moment that the first computing device 110 is detected, then the method may proceed to step 960 and output a notification. If the result of step 955 is that a notification should not be outputted at that moment, then step 965 may be performed and interaction information about the announcement message detected at step 930 may be stored (in the manner discussed above).

Example Embodiment where Encoded Profile Information Encomasses Answers to Non-Binary Questions

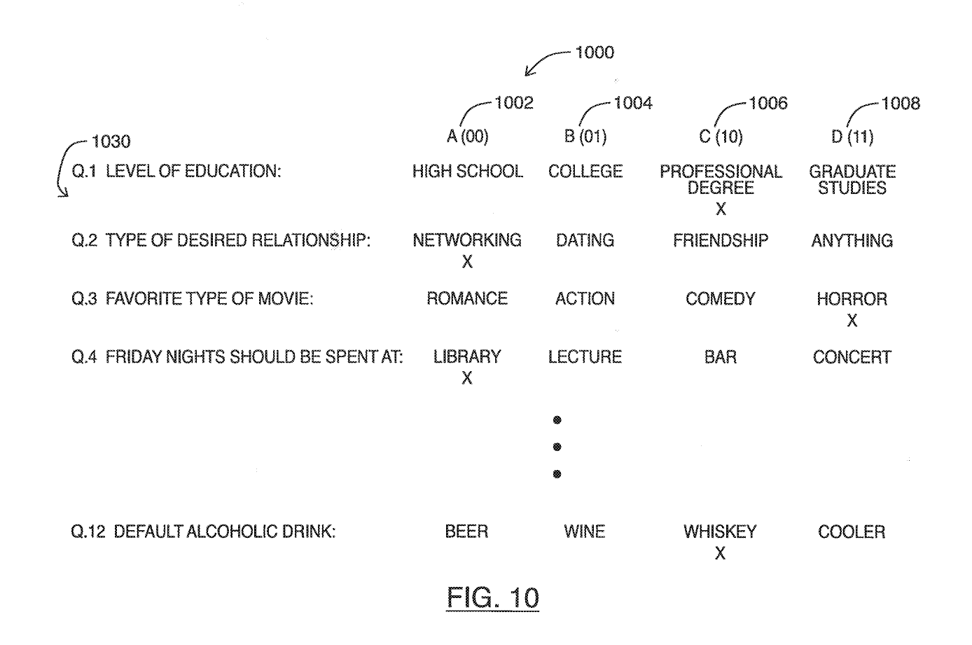

Referring to FIG. 10, shown there generally as 1000 is another example survey for which answers may be encoded into a data link layer address, in accordance with at least one embodiment of the present invention. The example survey illustrated in FIG. 10 has questions 1030 that can each encompass four answers.

As shown in FIG. 10, the four answers ‘A’ 1002, ‘B’ 1004, ‘C’ 1006, and ‘D’ 1008 to the various questions may be encoded into respective 2-bit encodings ‘00’, ‘01’, ‘10’, and ‘11’ that represent answers to the various questions. As illustrated, an example answer set for a user profile is displayed, where an answer to a given question is indicated with an ‘X’ underneath the selected answer. For example, as shown, question ‘1’ relates to the level of education a user has and answer ‘C’ for ‘Professional Degree’ is selected. Similarly, question ‘2’ relates to the type of desired relationship the user desires, and answer ‘A’ for ‘Networking’ is selected; question ‘3’ relates to the favorite type of movie the user likes, and answer ‘D’ for ‘Horror’ is selected; question ‘4’ relates to the type of venue the user enjoys spending Friday nights at, and answer ‘A’ for ‘Library’ is selected; and question ‘12 relates to the default alcoholic drink for the user, and answer ‘C’ for ‘Whiskey’ is selected. Questions ‘5’ to ‘7’ are omitted for ease of illustration.

Similar to the embodiments discussed above, the answers to the questions may be encoded into a non-OUI portion of a data link layer address. In an example where the non-OUI portion of a MA-L EUI-48 MAC address is used for encoding, there are 24-bits available for encoding.

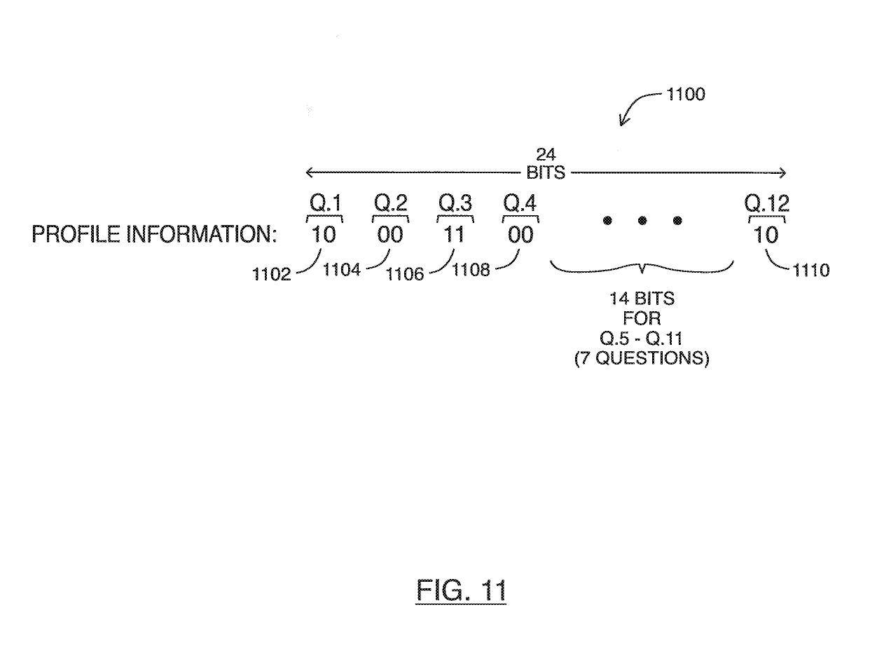

Referring simultaneously to FIG. 11, shown there generally as 1100 is an example layout of a 24-bit non-OUI portion of a MAC address, with the example answers of the survey of FIG. 10 encoded therein, in accordance with at least one embodiment of the present invention. As shown, the various answers from the answer set of FIG. 10 are encoded into sequential bits of the 24-bits available. For example, the answers to question ‘1’ and ‘12’ are encoded 1102, 1110 with the bits ‘10’ to represent answer ‘C’ 1006 in the answer set of FIG. 10. Similarly, the answers to question ‘2’ and ‘4’ are encoded 1104, 1108 with the bits ‘00’ to represent answer ‘A’ 1002 in FIG. 10; and the answer to question ‘3’ is encoded 1106 with the bits ‘11’ to represent answer ‘D’ 1008 in FIG. 10. Shown as ellipses in FIG. 11 are answers that would be encoded with 14 bits for the ‘7’ answers to questions ‘5’ to ‘11’.

Unlike the example survey discussed above in relation to FIG. 6, which had questions requiring binary (yes/no) answers being presented in a survey, the example survey of FIG. 10 had questions that required four answers. As the possibility of four different answers requires answers to be encoded in 2-bits, the survey of FIG. 10 has fewer (e.g., only ‘12’) questions to allow for all potential answers to still be encoded within the 24-bit allotment of the non-OUI portion of a MA-L EUI-48 MAC address. This is because the ‘12’ questions with 2-bit encoding each would take up the 24-bits available. Similarly, it may be possible to have ‘24’ binary questions that require 1-bit encodings to fill up the 24-bits available. In various embodiments, surveys with more or fewer questions with a varied number of answers may be encoded. For example, the survey may have questions that have ‘8’ possible answers (requiring a 3-bit encoding), and the survey may be limited to ‘8’ questions because ‘8’ questions multiplied by 3-bits each would take up the ‘24’ bits available. In other examples, a survey may have some combination of binary questions and types of questions with more than ‘2’ answers, and the answers can be encoded by allocating certain available bits to certain questions (e.g., the bit in position ‘1’ may encode an answer to a binary question, and the following two bits may encode a next question that has ‘4’ possible answers, etc.).

As noted above, the non-OUI portion of a data link layer address may vary in length depending on, for example, the format of the address (e.g., whether the address is an EUI-48 format address or an EUI-64 format address), the IEEE registry the address is assigned from (e.g., MA-S, MA-M, or MA-L), the type of protocol the data link layer address is being used with (e.g., MAC addresses for IEEE 802.3 or 802.11 protocols and BD_ADDR for Bluetooth™ protocols), or any combination of the foregoing. Although some of the embodiments described herein have been illustrated using 24-bit non-OUI portions of MA-L EUI-48 MAC addresses, the present embodiments may be used with any type or length of such data link layer addresses. Any survey with questions and respective possible answers (or other like profile information) that can be suitably encoded into available bits of non-OUI portions of such data link layer addresses are within the contemplation of the present embodiments.

While the embodiments discussed herein relate to existing MAC address formats such as EUI-48 and EUI-64, it will be understood that any future modification to the formats of these addresses are within the contemplation of the present disclosure. For example, one or more of the bit length of the OUI portion, a bit length of the non-OUI portion, a total length of a given address format, and/or any other modification to the address formats may be possible, and such modifications are within the contemplation of the present disclosure. Moreover, while the above discussion relates to the assignment of MAC addresses by the IEEE, it is possible that management and assignment of data link layer addresses may be passed on to a different analogous organization in the future. Any modifications to MAC address conventions or assignments of data link layer address by such analogous organization are also within the contemplation of the present disclosure.

Associating Profile Information with Profile Categories and Comparing Profile Information Based on Profile Categories

In various embodiments, the software module(s) for decoding and comparing profile information may be configured to perform the comparison based on profile categories that the profile information to be compared are respectively associated with. For example, continuing with the example survey discussed above in FIG. 10, it may be possible to create certain profile categories based on different subsets of answers to some of the various questions 1030 (as shown in FIG. 10).

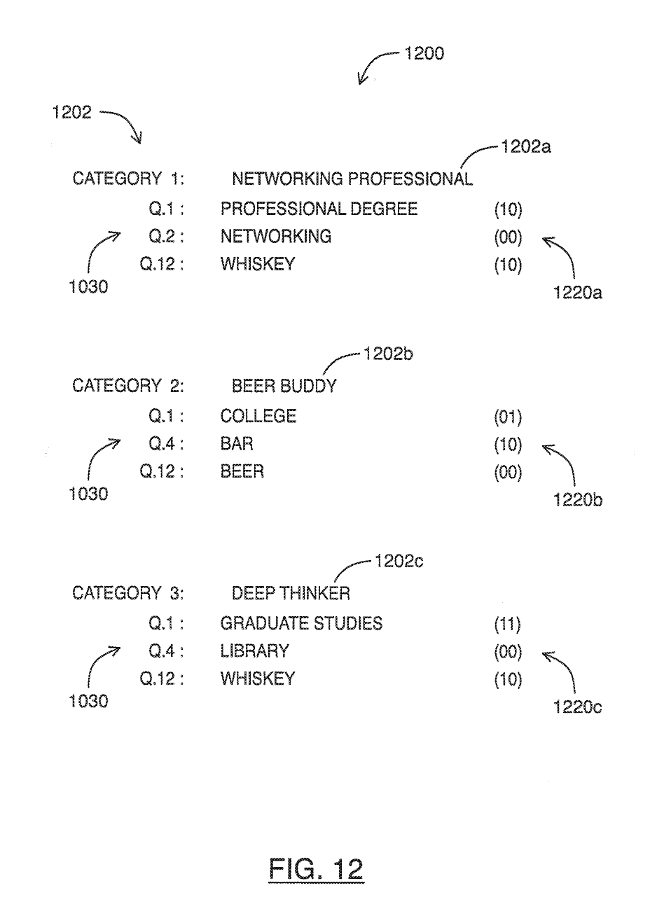

Referring to FIG. 12, shown there generally as 1200 are example profile categories that may be used in relation to the questions 1030 of the example survey of FIG. 10, in accordance with at least one embodiment of the present invention. As shown in FIG. 12, three example profile categories 1202 are shown: category ‘1’ 1202a for ‘Networking Professional’, category ‘2’ 1202b for ‘Beer Buddy’, and category ‘3’ 1202c for ‘Deep Thinker’. For category ‘1’, the collective answers of: ‘Professional Degree’ to question ‘1’ relating to level of education, ‘Networking’ to question ‘2’ relating to type of desired relationship, and ‘Whiskey’ to question ‘12’ relating to preferred alcoholic drink may be associated with the ‘Networking Professional’ category 1202a. Similarly, the collective answers of: ‘College’ to question ‘1’ relating to level of education, ‘Bar’ to question ‘4’ relating to preferred Friday night venue, and ‘Beer’ to question ‘12’ relating to preferred alcoholic drink may be associated with the ‘Beer Buddy’ category 1202b. Likewise, the collective answers of: ‘Graduate Studies’ to question ‘1’ relating to level of education, ‘Library’ to question ‘4’ relating to preferred Friday night venue, and ‘Whiskey’ to question ‘12’ relating to preferred alcoholic drink may be associated with the ‘Deep Thinker’ category 1202c.

The profile category that a given set of profile information is associated with may be determined based on similarities between the answers in the profile information and the subset of answers linked to a given profile category. In some embodiments, this may be determined based on a k-nearest neighbor analysis of the answers in the profile information against the possible answers associated with each of the available profile categories. As will be understood by persons skilled in the art, a k-nearest neighbor analysis may be used to classify unknown information to known categories, where the unknown information is assigned the category that is most common among its k nearest neighbors in the data set. In an example embodiment (e.g., where k=1), such an analysis may involve determining which profile category the given profile information has the most common answers with (in effect, identifying the closest neighbor of the possible profile categories that the profile information is closest to). Although an example embodiment using the k-nearest neighbor analysis has been discussed herein, other machine learning algorithms may be used in various embodiments (e.g., such other algorithms may be used to determine a profile category that a given set of profile information is associated with, or to determine the level of compatibility and similarities between two given sets of profile information).

Referring simultaneously to FIG. 13, shown there generally as 1300 are example comparisons between the encoded answers to the survey of FIG. 10 and encoded example profile categories of FIG. 12, for the purpose of assigning the answers to a profile category, in accordance with at least one embodiment of the present invention. Continuing on with the examples discussed above in relation to FIGS. 10-12, the profile information shown in the top row of FIG. 13 are the encoded answers shown in FIG. 11. Specifically, shown are the various encoded answers 1102, 1104, 1106, 1108, and 1110 to questions ‘1’, ‘2’, ‘3’, ‘4’, and ‘12’ respectively.

Below the profile information are the three example profile categories ‘1’, ‘2’, and ‘3’ of FIG. 12 shown in encoded form. For the answers to questions ‘1’, ‘2’, and ‘12’ associated with category ‘1’ 1202a, the respective encoded answers of ‘10’, ‘00’, and ‘10’ correspond to the encoded answers 1220a for those questions in category ‘1’ 1202a shown in FIG. 12. Similarly, for the answers to questions ‘1’, ‘4’, and ‘12’ associated with category ‘2’ 1202b, the respective encoded answers of ‘01’, ‘10’, and ‘00’ correspond to the encoded answers 1220b for those questions in category ‘2’ 1202b shown in FIG. 12. Likewise, for the answers to questions ‘1’, ‘4’, and ‘12’ associated with category ‘3’ 1202c, the respective answers of ‘11’, ‘10’, and ‘00’ correspond to the encoded answers 1220c for those questions in category ‘3’ 1202c shown in FIG. 12. As illustrated in FIG. 13, where the profile category has no defined answer for a given question, ‘XX’ is shown in the spot where such an answer would normally be encoded to indicate that such bits are not going to be relevant for the similarities analysis between the profile information and the profile categories.

Still referring to FIG. 13, it can be seen that the profile information has no answers in common with the encoded answers 1308 for category ‘2’ 1202b. Whereas category ‘3’ has answers to question ‘4’ 1320 and question ‘12’ 1322 in common (as shown in dotted outline), it can be seen that amongst the three example profile categories ‘1’, ‘2’, and ‘3’, the profile information has the most answers in common with category ‘1’ because it has answers to question ‘1’ 1302, question ‘2’ 1304, and question ‘12’ 1306 in common (also shown in dotted outline). Based on this analysis, a computing device may determine that category ‘1’ is the closest neighbor to the example profile information of FIGS. 10 and 11 and assign such profile information to be associated with category ‘1’.

In embodiments where profile categories are used, the second computing device 130 (as discussed above in relation to FIGS. 1 and 2) may assign profile categories to both the first profile information extracted from a data link layer address of an announcement message and the second profile information stored on the second computing device 130. In such case, the steps discussed above in relation to comparison of the different profile information (e.g., step 225 of FIG. 2 and step 940 of FIG. 9) may additionally or alternatively be performed based on the respective profile categories each of the first and second profile information is associated with. In such embodiments, the second computing device 130 may be configured to also perform the steps described herein for associating profile information with a profile category to the profile information it stores in profile database 114b of FIG. 1. Such steps may, for example, be performed prior to the announcement message being received to avoid delay in performing the comparison step upon receipt of an announcement message.

When comparing profile categories, the second computing device 130 may determine that the first computing device 110 is suitable for communication with the second computing device 130 if the comparison indicates the respective profile categories are sufficiently similar. In one example, the second computing device 130 may determine there is sufficient similarity between two profile categories if the two profile categories match.

However, in other embodiments, the second computing device 130 may determine there is sufficient similarity between two profile categories simply if there are common answers between the answers associated with one profile category and the answers associated with another profile category. For example, referring again to FIG. 13, it can be seen that both category ‘1’ and category ‘3’ have ‘10’ encoded as the answer to question ‘12’. In such case, even if a given first computing device 110 has encoded profile information that is determined to be associated with category ‘1’, and the stored profile information at a second computing device 130 is determined to be associated with category ‘3’, the second computing device 130 may determine that a threshold has been met and notify the user of the second computing device 130 that a first computing device 110 has been located. Such looser rules for determining when a given device is suitable for communication may be desirable, for example, to increase the number of compatible device matches. The particular threshold number of common number of answers may be configured to calibrate the number of compatible devices located.

Additionally or alternatively, the second computing device 130 may determine that the first computing device 130 is not suitable for communication with the second computing device 130 if the comparison between a first profile category (associated with the first computing device 110) and a second profile category (associated with the second computing device 130) indicate that the two profile categories are sufficiently dissimilar. For example, in the above embodiment where the profile categories contain encoded answers to survey questions, this may involve determining a threshold number of maximum-allowable different answers between the profile categories. In such embodiments, if the first and second profile categories contain encoded answers to certain questions and this maximum-allowable threshold number of different answers is met or exceeded, then the second computing device 130 may eliminate the first computing device 110 (as associated with the first profile category) from being considered to be suitable for communication with the second computing device 130.

In some such embodiments, the second computing device 130 may be configured to compare profile categories on the basis of both: (i) a threshold number of minimum common answers for assessing profile category compatibility, and (ii) a threshold number of maximum-allowable different answers for assessing profile category non-compatibility (e.g., if this threshold number is met or exceeded, the first computing device 110 associated with the profile category is eliminated from being considered compatible). In such embodiments, it is possible that comparisons of profile categories using these two types of threshold numbers may result in a conflicting determination of device compatibility (e.g., if both the threshold numbers are low, there may be both a sufficient number of common answers for determining profile category compatibility, and a sufficient number of different answers for determining profile category non-compatibility). Accordingly, in such embodiments, the second computing device 130 may be configured to prioritize the result of one threshold number over the other threshold number.

As described above, the encoding of profile information into data link layer addresses may enhance privacy for the user of the first computing device 110. For example, as noted, the encoded profile information may reflect answers to questions in a survey. By performing the encoding described herein, all that is being shared with a second computing device 130 are the encoded answers. Notably, no personally identifiable information (PII) such as a user's name is revealed. Indeed, even an Internet Protocol (IP) address would not be provided to the second computing device 130 in the announcement message, as the encoded information is provided in the address of a lower level (the data link layer) of the OSI model. In contrast to applications that attempt to protect privacy by masking the true MAC address of a computing device (e.g., to avoid a potentially nefarious computing device from receiving it), the embodiments described herein can use the MAC address to encode pertinent information about the user in a controlled manner without revealing other types of information from the computing device that may not be desired to be disclosed.

### Example Possible Other Embodiments

The example embodiments above have been described in the context of enabling person-to-person communications between users of first and second computing devices. However, in other embodiments, the present embodiments may be used to create communication networks amongst a group of people who all have similar interests based on their profiles (e.g., a so-called “flash”, “filtered” or impromptu mesh network created based on profiles available on a number of nearby devices).

For example, in some such embodiments, profile information 120a (as shown in FIG. 1) may be encoded into the BSSID field 306 of a 802.11 beacon frame (as shown in FIG. 3). As will be understood persons skilled in the art, the BSSID field 306 is usually filled with the MAC address of the Wireless AP broadcasting the beacon frame. However, in the embodiments provided herewith, instead of using the data in the BSSID field 306 to identify the physical AP that a device is connecting to, the BSSID field 306 can be used to encode profile information 120a. Devices broadcasting similar or common profile information 120 in their respective BSSID fields 306 may then be considered a part of the “filtered” mesh network.

In other embodiments, the techniques described herein may be used to enable communications between businesses to people or businesses to business. For example, it may be possible to encode purchasing preferences in the profile information described herein (for a computing device used by a person), or marketing information in the profile information (for a computing device used by a business). A given computing device may then be determined to be suitable for communication with the other if there is a match determined between the purchasing preference and items being marketed.

In further embodiments, the techniques described herein may be used for proximity authentication. For example, a second computing device 130 may be seeded with a unique identifier from the first computing device 110 through some communication means outside of the methods for announcing device communication availability discussed herein. This unique identifier may then form the basis of the second profile information stored at the second computing device 130 that the second computing device 130 compares extracted profile information to (e.g., as extracted from announcement messages). A first computing device 110 having access to this unique identifier may then encode it into an announcement message and broadcast it within a given geographical location. If the second computing device 130 enters the geographical location and detects the announcement message having this unique identifier encoded therein, the second computing device 130 may then output a notification to inform a user that they are now within the proximity of the first computing device 110.

This latter embodiment may have applicability in a restaurant reservation environment. For example, the unique identifier discussed above may be a reservation number which can be encoded into a MAC address (in the manner discussed above). When making a reservation, the second computing device may receive (e.g., by email) the reservation number. This reservation number may then be stored as the second profile information discussed above that extracted profile information from announcement messages are compared to. Near the time of the reservation, the restaurant may then broadcast announcement messages with this reservation number encoded within a MAC address, so that when the potential customer arrives, their computing device will determine a match between the encoded reservation number and the reservation number they had previously received. The second computing device 130 may then be notified that they are within the proximity of the restaurant. This may be desirable, for example, if the restaurant is difficult to find.

Additionally or alternatively, the customer's computing device may serve as the first computing device 110 and encode the reservation number into a MAC address of an announcement message that the customer's computing device broadcasts. A computing device at the restaurant may then act as the second computing device 130 to detect for announcement messages. When the customer's computing device is nearby and enters wireless communication range, the restaurant's computing device (acting as the second computing device 130) may then determine a match between the encoded reservation number being broadcasted by the customer's computing device and an entry in the database of reservation numbers it has stored. The computing device at the restaurant may then output a notification to inform restaurant staff that the patron is about to arrive. This latter embodiment may be desirable for example if, for example, the regular network connection of the customer's computing device is lost near the restaurant (e.g., if the restaurant is in an area with a particularly weak cellular signal) and they are unable to inform the restaurant otherwise.

As has been described above with respect to various embodiments, profile information may be encoded into the data link layer address that is broadcasted from a computing device. Traditionally, such data link layer addresses are designed to be unique identifiers for a given computing device. However, by encoding profile information into such addresses in the present embodiments, it may be possible that an identical match is created between two such addresses at two respective devices. In this scenario, there may be a collision between the two data link layer addresses. To account for this possibility, in some embodiments, the encoding module 112 (as shown in FIG. 1) may be configured to append specific information (e.g., to a beacon frame of FIG. 3, as discussed above) that would distinguish individual computing devices. For example, such appended information may include geographic coordinates, time stamps, and/or one or more outputs (or combinations of outputs) of functions that provide characteristics of a given computing device (e.g., battery life, or number of megabytes downloaded on a given day).

When the decoding module 132 (as shown in FIG. 1) receives a broadcasted data link layer address that is a perfect match to its own data link layer address, it may be further configured to provide a special notification that a highly-compatible computing device has been located. As will be understood by persons skilled in the art, traditional computing devices may traditionally discard messages when an identical data link layer is detected (e.g., it normally discards messages that originated from itself). However, in the present embodiments, the second computing device 130 identifying a perfect match for the profile information encoded into the non-OUI portion of a received data link layer address (e.g., after it determined that profile information was actually encoded into the data link layer address, based on a compatible or matching OUI-portion of the received data link layer address, as discussed above) may instead provide a special notification that there is a highly-compatible first computing device with which communication may be desired.

All publications and patent applications mentioned in this specification are herein incorporated by reference to the same extent as if each individual publication or patent application was specifically and individually incorporated by reference.

While the foregoing disclosure has been described in some detail for purposes of clarity and understanding, such disclosure is provided by way of example only. It will be appreciated by one skilled in the art, from a reading of the disclosure that various changes in form and detail of these exemplary embodiments can be made without departing from the true scope of the disclosure, which is limited only by the appended claims. For example, it should be understood that acts and the order of the acts performed in the processing described herein may be altered, modified and/or augmented (whether or not such steps are described in the claims, figures or otherwise in any sequential numbered or lettered manner) yet still achieve the desired outcome. While processes or blocks are presented in a given order, alternative examples may perform routines having steps, or employ systems having blocks, in a different order, and some processes or blocks may be deleted, moved, added, subdivided, combined, and/or modified to provide alternatives or subcombinations. Each of these processes or blocks may be implemented in a variety of different ways. Also, while processes or blocks are at times shown as being performed in series, these processes or blocks may instead be performed in parallel, or may be performed at different times.

In the various user interfaces illustrated in the figures, it will be understood that the illustrated user interface text and controls are provided as examples only and are not meant to be limiting with regards to their appearance. Other suitable ways of arranging and modifying the appearance of user interface elements may be possible.

Those skilled in the relevant art will appreciate that aspects of the system can be practised with other communications, data processing, or computer system configurations, including: Internet appliances, cloud computing, multi-processor systems, microprocessor-based or programmable devices, network PCs, mini-computers, mainframe computers, and the like.

Software and other modules may be accessible via local memory, via a network, via a browser or other application in an Application Service Provider (ASP) context, or via other means suitable for the purposes described herein. Examples of the technology can also be practised in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices. Data structures (e.g., containers) described herein may include computer files, variables, programming arrays, programming structures, or any electronic information storage schemes or methods, or any combinations thereof, suitable for the purposes described herein.

Where a component (e.g. a model, processor, scheduler, display, data store, software module, assembly, device, circuit, etc.) is referred to above, unless otherwise indicated, reference to that component should be interpreted as including as equivalents of that component any component which performs the function of the described component (i.e., that is functionally equivalent), including components which are not structurally equivalent to the disclosed structure which performs the function in the illustrated exemplary embodiments of the invention.

As used herein, the wording “and/or” is intended to represent an inclusive-or. That is, “X and/or Y” is intended to mean X or Y or both. Moreover, “X, Y, and/or Z” is intended to mean X or Y or Z or any combination thereof.

What is claimed is:

1. A method of announcing communication availability from a first computing device, the method comprising:
encoding first profile information into an announcement message, wherein the announcement message comprises an address field for storing a data link layer address, and the first profile information is encoded into the data link layer address stored in the address field; and
broadcasting the announcement message;
wherein upon receipt of the announcement message at a second computing device, the second computing device:
decodes the data link layer address stored in the address field of the announcement message, to extract the first profile information,
compares the first profile information to second profile information stored at the second computing device, and
based on the comparison, determines whether the first computing device is suitable for communication with the second computing device.

2. The method of claim 1, wherein the announcement message is formatted according to Institute of Electrical and Electronics Engineers (IEEE) 802 standards.

3. The method of claim 1, wherein the data link layer address comprises a BD_ADDR address for use with a Bluetooth™ protocol.

4. The method of claim 1, wherein the data link layer address comprises a Medium Access Control (MAC) address.

5. The method of claim 1, wherein the announcement message comprises a beacon frame of the IEEE 802.11 standard.

6. The method of claim 1, wherein the data link layer address comprises an Organizationally Unique Identifier (OUI) portion and a non-OUI portion, and the first profile information is encoded into the non-OUI portion of the data link layer address.

7. The method of claim 6, wherein prior to decoding the data link layer address stored in the address field of the announcement message, the second computing device:
reads the OUI portion of the data link layer address,
compares the OUI portion of the data link layer address to OUI information stored at the second computing device, the OUI information stored at the second computing device being associated with computing devices that perform the encoding, and
determines to proceed with the decoding if the OUI portion of the data link layer address matches any of the OUI information stored at the second computing device.

8. The method of claim 1, wherein during the encoding of the data link layer address into the address field of the announcement message, the data link layer address temporarily overwrites a burned-in data link layer address of the first computing device.

9. The method of claim 1, wherein upon determining that the first computing device is suitable for communication, the second computing device:
outputs a notification, and
transmits a signal to the first computing device to request initiation of a network communication.

10. The method of claim 9, wherein the network communication requested to be initiated by the second computing device comprises a network configured according to an Ad-Hoc mode of the IEEE 802.11 standard.

11. A method of determining whether a first computing device is suitable for communication with a second computing device, the method comprising the second computing device:
receiving an announcement message from the first computing device, the announcement message comprising an address field for storing a data link layer address;
decoding the data link layer address stored in the address field of the announcement message, to extract first profile information;
comparing the first profile information to second profile information stored at the second computing device; and
based on the comparison, determining whether the first computing device is suitable for communication with the second computing device.

12. The method of claim 11, wherein the announcement message is formatted according to Institute of Electrical and Electronics Engineers (IEEE) 802 standards.

13. The method of claim 11, wherein the data link layer address comprises a BD_ADDR address for use with a Bluetooth™ protocol.

14. The method of claim 11, wherein the data link layer address comprises a Medium Access Control (MAC) address.

15. The method of claim 11, wherein the announcement message comprises a beacon frame of the IEEE 802.11 standard.

16. The method of claim 11, wherein the data link layer address comprises an Organizationally Unique Identifier (OUI) portion and a non-OUI portion, and the first profile information is encoded into the non-OUI portion of the data link layer address.

17. The method of claim 16, wherein prior to decoding the data link layer address stored in the address field of the announcement message, the method further comprises the second computing device:
reading the OUI portion of the data link layer address,
comparing the OUI portion of the data link layer address to OUI information stored at the second computing device, the OUI information stored at the second computing device being associated with computing devices that perform the encoding, and
determining to proceed with the decoding if the OUI portion of the data link layer address matches any of the OUI information stored at the second computing device.

18. The method of claim 11, wherein upon determining that the first computing device is suitable for communication, the method further comprises the second computing device:
outputting a notification, and
transmitting a signal to the first computing device to request initiation of a network communication.

19. The method of claim 18, wherein the network communication requested to be initiated by the second computing device comprises a network configured according to an Ad-Hoc mode of the IEEE 802.11 standard.

20. A system for announcing communication availability, the system comprising:
a first computing device configured to:
encode first profile information into an announcement message, wherein the announcement message comprises an address field for storing a data link layer address, and the first profile information is encoded into the data link layer address stored in the address field, and
broadcast the announcement message; and
a second computing device configured to:
receive the announcement message from the first computing device,
decode the data link layer address stored in the address field of the announcement message, to extract the first profile information;
compare the first profile information to second profile information stored at the second computing device; and
based on the comparison, determine whether the first computing device is suitable for communication with the second computing device.
